(19) United States
(12) Patent Application Publication
(10) Pub. No.: US 2007/0153105 A1
(43) Pub. Date: Jul. 5, 2007

(54) Method and device of high efficiency image capturing

(76) Inventor: Chih-Ta Star Sung, Glonn (DE)

Correspondence Address: Chih-Ta Star SUNG;RM. 308, BLD. 52, NO.195, CHUNG HSING RD., SEC. 4 , CHU TUNG TOWNSHIP., HSINCHU COUNTY, 310, TW

(21) Appl. No.: 11/319,295

(22) Filed: Dec. 29, 2005

(51) Int. Cl. H04N 9/04

(52) U.S. Cl. 348/272

(57) ABSTRACT

A method and device of image capturing comprising of timing control of sequentially placing the corresponding color filter to top of the image sensor allows an image sensor cell to capture multiple colors and produce output of multiple colors. Thin films are applied to function as color filters to be turn on and off by electrical field. A semiconductor image sensor cell with micron-lens on top allows all light to penetrate into the photo diode and form variable voltage difference among different colors' sequence.

### BACKGROUND OF THE INVENTION

1. Field of Invention

The present invention relates to the method and device of high efficiency image capturing, and more specifically for capturing multiple colors per image sensor cell.

2. Description of Related Art

Semiconductor technology migration trend has driven the digital image and display feasible and has hence created wide applications including digital still camera, scanner, digital video recorder, web camera, 3G mobile phone, Digital TV, . . . etc.

In the past decade, many approaches have been invented for digital image, the most commonly adopted digital image technology has the first procedure of image capturing by using semiconductor image sensor devices including CCD, charge coupled device and CMOS image sensors.

Most prior art image sensors can capture only one color per image sensor cell which turns out to be one color per pixel. Applying interpolation technique adds two other color components to form the 3 color components, said Red, Green and Blue for each pixel which resolution is degraded. Another prior art of image capturing is to use a complex semiconductor process of three wells with three color filter right on to of each opening of the color well to capture the 3 colors as shown in FIG. 2. Both prior art approaches have draw back of either low color density each image sensor or complex and costly semiconductor process with somehow larger cell size.

This invention takes new alternative and more efficiently overcomes the setbacks of prior art image capturing techniques. With the invented method, an image sensor can capture multiple colors or said three colors, Red, Green and Blue.

### SUMMARY OF THE INVENTION

The present invention of the high efficiency image capturing significantly improves the density and resolution per image sensor which captures the image.
The present invention of the high efficiency image capturing applies multiple color filters on top of the semiconductor image sensor array to let only one color of light to penetrate and to hit the image sensor array.
The present invention of the high efficiency image capturing applies glass or plastic or any thin film color filters on top of the semiconductor image.
According to an embodiment of the present invention of the high efficiency image capturing, a reading circuit in each image sensor cell read out the image information captured in the cell.
According to an embodiment of the present invention of the high efficiency image capturing, one color filter is applied to top of the image sensor to let only one color to penetrate to the image sensor at a scheduled time.
According to an embodiment of the present invention of the high efficiency image capturing, the reading circuit within an image sensor cell reads the image information captured in the cell n a scheduled time.
According to an embodiment of the present invention of the high efficiency image capturing, after reading the color information, the image sensor cell will be reset and be ready for capturing the next color.
According to an embodiment of the present invention of the high efficiency image capturing, the color filters can be made from thin films and stacked with insulator and be turned on electrically to allow only one color to penetrate into the image sensor array at a scheduled time.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 depicts a prior art of a semiconductor image sensor which can capture one color component each pixel.

FIG. 2 depicts another prior art of a semiconductor image sensor which can capture three color components each pixel.

FIG. 3 illustrates the image capturing semiconductor image sensor array which could be a CCD or a CMOS image sensor.

FIG. 4 illustrates the method and device of the present invention of the image capturing by applying three changeable color filters to capture three color in per image sensor cell.

FIG. 5 depicts the semiconductor image sensor device.

FIG. 6 illustrates the method and device of the present invention of the image capturing by applying three electrically changeable color filters to the top of semiconductor image sensor with three color filters mixed in a liquid crystal material.

FIG. 7 shows the timing diagram of the image sensor reading mechanism.

FIG. 8 illustrates the reading circuit of the semiconductor image sensor.

### DESCRIPTION OF THE PREFERRED EMBODIMENTS

Most electronic devices within an image related system include a semiconductor image sensor functioning as an image capturing device as shown. The image sensor can be a CCD or a CMOS image sensor. Most image and video compression algorithms, like JPEG and MPEG have been developed in late 1980s' or early 1990s'. The CMOS image sensor technology was not mature then. The CCD sensor has inheriting higher image quality than the CMOS image sensor and has been used in applications requires image quality like scanner, high-ended digital camera or camcorder or surveillance system or the video recording system.

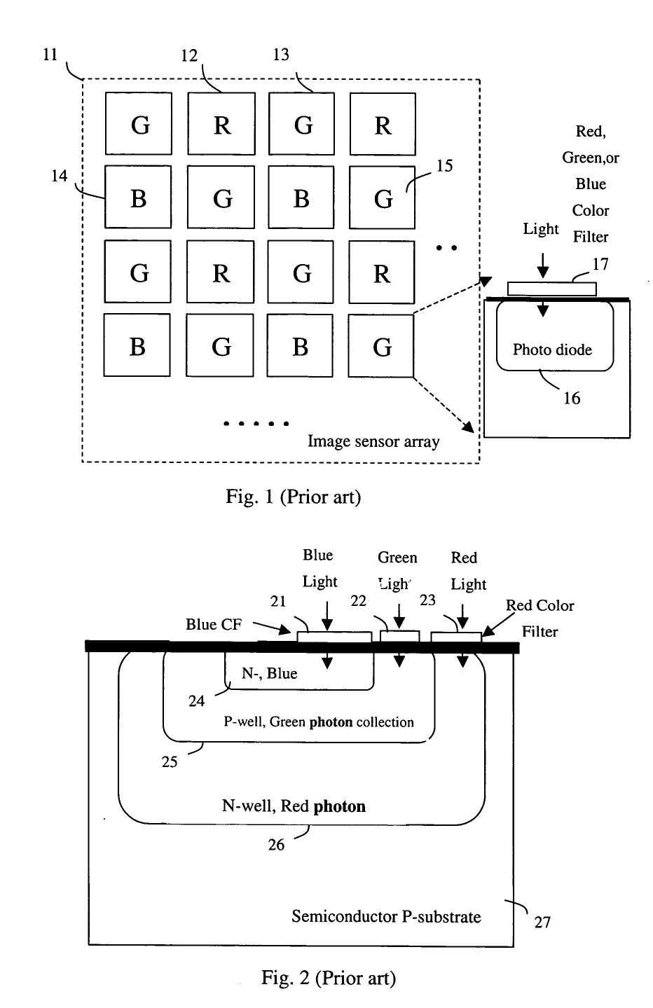

An image sensor is to capture the image by measuring the amount of red photons, green photons and blue photons by either using CCD, a charge coupled device or a CMOS image sensor array. An image sensor cell comprising of no matter a CCD or a CMOS image sensor, can capture only one color by each cell as shown in FIG. 1 by applying one of the three color filters 17 on top of the sensor cell.

Each pixel of a CMOS active-pixel image sensor contains not only the photo-detector element, a photo diode 16 or a photo gate but also active transistor circuitry, or said an amplifier for readout of the pixel signal. The bigger the pixel, the more light it can collect. Thus, big-pixel sensors work best under low-light conditions. For the same number of pixels, bigger pixels result in a bigger chip, which means higher cost. For allowing only a selected color photons to punch the predetermined location of an image sensor die, a specific color filter pattern or sequence of filters can be designed. The Bayer CFA pattern coming out of one row of RGRGRGRG . . . followed by the next row of GBGBGBGB . . . was invented long ago at Kodak and is a repeating 2×2 arrangement 12, 13, 14, 15 has been widely adopted.

Another prior art of the image capturing with a semiconductor image sensor is shown in FIG. 2 has been granted a U.S. Pat. No. 5,965,875. This figure is an example of P-type substrate 27 with three well layers which used to form photo diode with capability of capturing and storing variable colors. These three wells include N-well 26 on P-substrate for capturing Red photons, P-well 25 on the N-well which captures Green photons and another N-well 24 on the P-well which captures the Blue photons. The three wells form three vertical photo diodes and represent three color capturing devices with each having corresponding color filters, Blue color filter 21, Green color filter 22 and Red color filter 23 on top of it. Drawbacks of the U.S. Pat. No. 5,965,875 include:
Complex and expensive semiconductor process of additional three wells which require more masks and more process layers.
Relatively larger image sensor cell size per pixel: since it implements three color filters on top of a cell, the area size is larger than conventional ones.
   Even the quality has sharply improved compared to conventional one color per pixel, the cost of implementation and cell size still have room to improve.

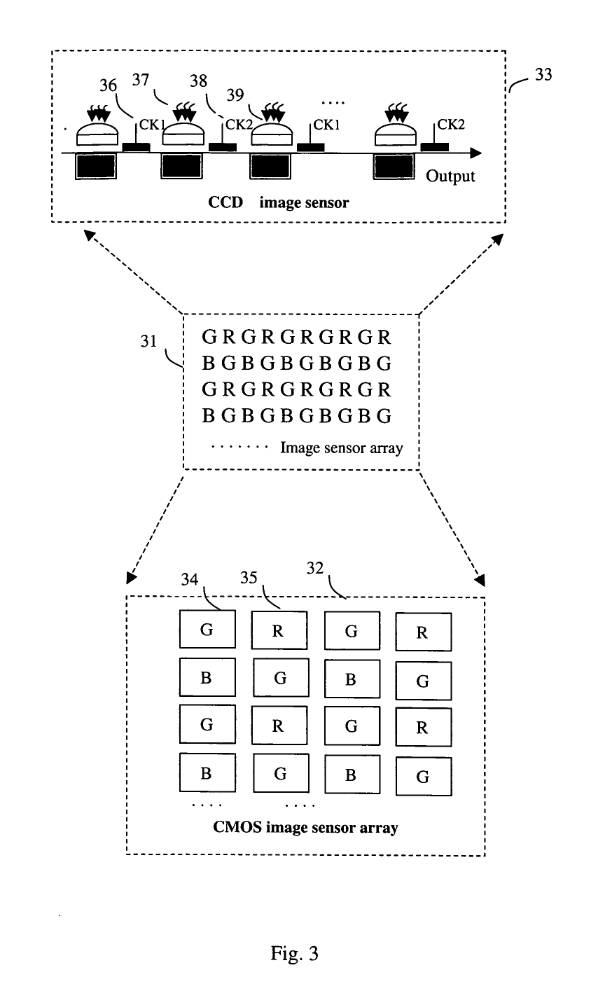

FIG. 3 depicts the semiconductor image sensor 31 which can be made of CCD 33 or CMOS 32 materials. A CMOS image sensor array is formed like a memory array with each location of row or column can be randomly accessed. And each image sensor cell can capture one color 34, 35 can provide an amplified image information. The CCD image sensor is different the CMOS sensor. The colors captured sensor cells 37, 39 . . . can be transferred seriously to the next cell till the end of row/column by two non-overlapping clocks 36, 38.

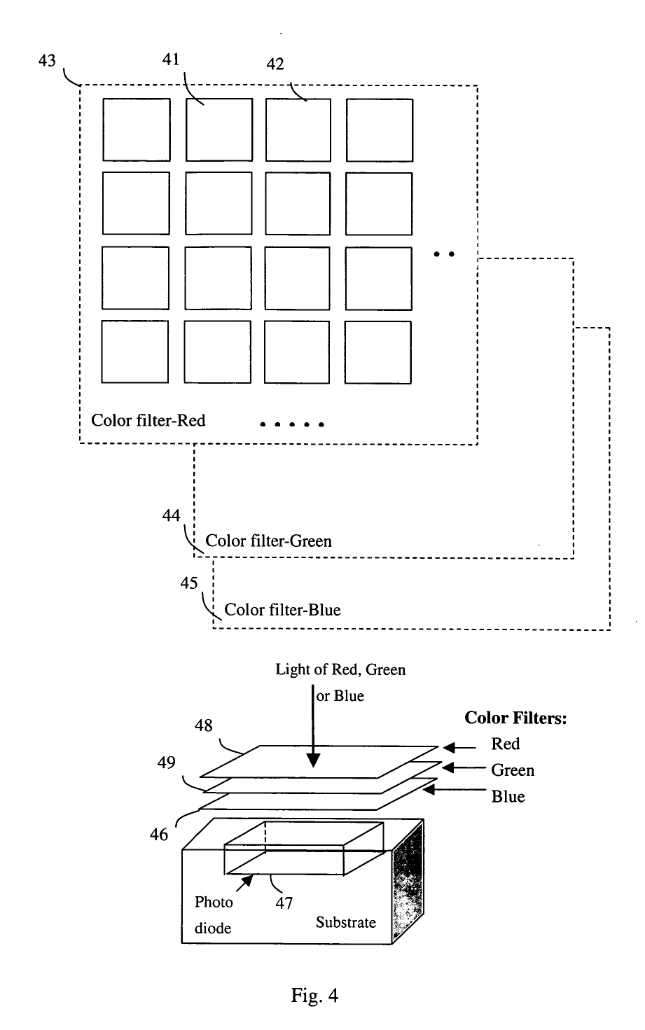

As shown in FIG. 4, the present invention of the method and device of the efficient image capturing improves the drawbacks of prior arts including
Quality enhancement of capturing 3 colors per image sensor cell
Simple semiconductor process
Small sensor cell size: achieving low cost

Multiple color filters 43, 44, 45 are designed and can be placed on top or all image sensor cells 41, 42 . . . . Only one selected color filter is placed on top if the image sensor at the scheduled time. For example, Red, Green and Blue are designed to be the selected three color filters. In the application of the color image scanner as an example, firstly, the red filter 48 is placed on top of the image sensor to let only the red light penetrate through the red color filter and hit the image sensor array, the photo diodes 47, then, the image sensor circuit reads out the red color information. In the second scheduled time slot, the green filter 49 is placed on top of the image sensor to let only the green light penetrate through the green color filter and hit the image sensor array, the photo diodes 47, afterward, the image sensor circuit reads out the green color information. In the third scheduled time slot, the blue filter 46 is placed on top of the image sensor to let only the blue light penetrate through the blue color filter and hit the image sensor array, the photo diodes 47, afterward, the image sensor circuit reads out the blue color information. By applying three color filters in scheduled time and placing on top of image sensor as above mechanism, each image sensor cell can hence capture three color components in seriously scheduled timing.

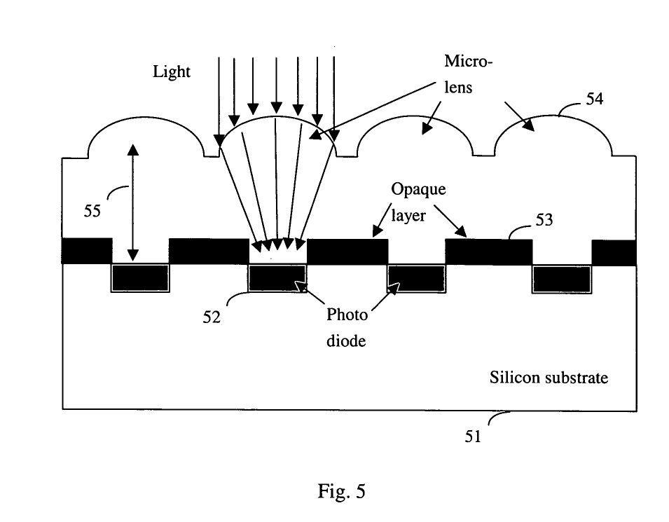

FIG. 5 illustrates the structure of the image sensor for this invention of the efficient image capturing, which can be a CCD sensor or a CMOS sensor. The photo diode 52, the image sensing element, is formed on top of the semiconductor substrate 51. An opaque layer 53 is formed on top of the area between two photo diodes to block light penetrating to the substrate. For attracting more lights, the micro-lens 54 is formed above the substrate by a predetermined distance 55 which is proportional to the area of the sensing photo diode.

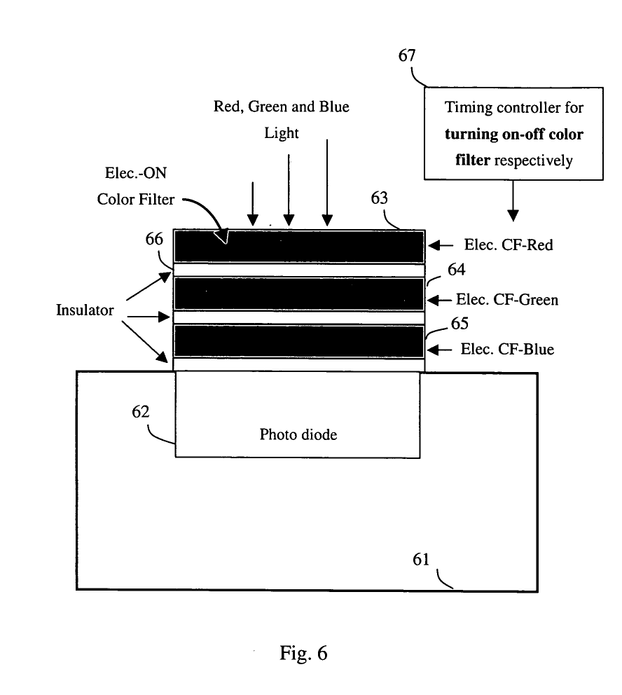

Placing a selected color filter to be placed on top of the image sensor at a scheduled time can be replaced by another method of applying color filter made of thin film material which is turning on and off electrically as shown in FIG. 6. The image sensing photo diode 62 is formed on top of the semiconductor substrate 61. The electrically On-Off controlled thin film color filters 63, 64, 65 are placed on upper layers of the image sensor and been isolated by insulation layers 66. The insulation material can be glass or plastic with good polarization effect to avoid reducing the energy of light. In some applications, like digital camera, video camcorder requiring high speed of changing the color filters, an accurate timing controller 67 is designed for turning on and off the thin film color filters in a precisely determined timing.

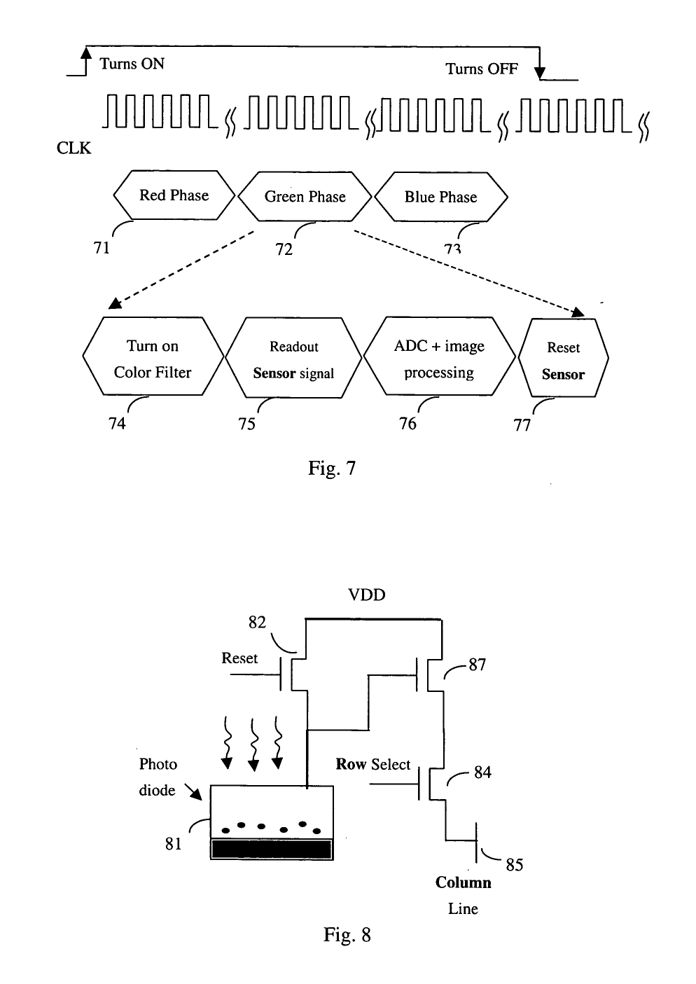

FIG. 7 shows the timing and corresponding procedures of this invention of the efficient image capturing. Each image capturing procedure is divided into three phases of red phase 71, green phase 72 and blue phase 73. Each phase of a selected color capturing and processing includes a couple of procedures of placing color filter, readout color signal, digitization and image processing and reset. The 1^{st} procedure is placing color filter 74 letting the selected color of light shoot to the image sensor, the readout sensor information which conducts the photo diode to a source follower circuit with amplification and place the output to a column node. The readout signal will be converted to digital format by an analog-to-digital-converter, ADC for image processing including gamma correction, white balance, auto exposure . . . . When all procedures are done, a reset signal turns on the transistor to discharge all charges stored in the photo diodes.

FIG. 8 depicts the readout circuitry of the sense amplifier. A photo diode 81 captures the photons and forms positive voltage conducts to the gate of the source follower device 83 which amplifies the photo signal. The output of the source follower connects to the Row select device 84 of each column 85 and the output voltage on the column will be converted to digital signal by an ADC, analog-to-digital-converter for further image processing.

The present invention of the efficient image capturing enhances the image quality by capturing multiple colors, for example said red, green and blue in each image sensor cell be placing the corresponding color filter on top of the image sensor in a scheduled time. It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of capturing image, comprising:
deploying image sensor array comprising light sensing elements to capture the color photon;
sequentially placing one color filter on top of image sensor to let a selected color light to penetrate through the color filter in the schedule time; and
reading out the image signal stored in the image sensor array in scheduled time.

2. The method of claim 1, wherein an analog-to-digital convert circuit is applied to transform the captured image signal in the image sensor cell into digital format with one color representation per pixel.

3. The method of claim 1, wherein the color filters are made of glasses with variable material allowing selected color photons with a certain wavelength range to penetrate.

4. The method of claim 1, wherein the color filters are made of plastic with variable material allowing selected color photons with a certain wavelength range to penetrate.

5. The method of claim 1, wherein the image sensor cell is made of a semiconductor photo diode.

6. The method of claim 1, wherein at the predetermined time, the existing color filter is replaced by another color filter and allowing the new corresponding color to penetrate to the image sensor array.

7. The method of claim 1, wherein the color filters are comprised of at least Red, Green and Blue colors.

8. A method of the capturing image by using thin films as color filters, comprising:
implementing an image sensor array comprising photo sensing elements to capture the photon penetrating through the color filter;
applying at least two color filters making of thin films for each color filter on top of the semiconductor image sensor;
turning on one thin film color filter at scheduled timing; and
reading out the image signal stored in the image sensor array in the scheduled time.

9. The method of claim 9, wherein the color filter is made of thin film material which is plated to top of an insulator.

10. The method of claim 9, wherein the insulator is a glass material.

11. The method of claim 9, wherein the insulator is a plastic material.

12. The method of claim 8, wherein one of the color filters is functioning at a time and allowing only the light with selected color to penetrate while other color filters are dummy and allowing all light to penetrate.

13. The method of claim 8, wherein the color filters are turning on by applying the electrical field and turning off by removing the electrical field.

14. A device of capturing image, comprising
a semiconductor substrate;
an image sensor making of a photo diode and a readout circuitry on top of the substrate, having capability of capturing the image by detecting the photons of variable colors and reading out the captured image;
an opaque layer on top of the substrate, but not covering the image sensor photo diode area; and
a micro-lens on top of the image sensor and surrounding area concentrating more light to penetrate to the photo diode.

15. The apparatus of claim 14, wherein the opaque material blocks the light to penetrate into the semiconductor substrate and to avoid forming current flow on the surface of the semiconductor substrate.

16. The apparatus of claim 14, wherein the opaque layer is a made of metal.

17. The apparatus of claim 14, wherein the readout circuitry reads the corresponding color out from the image sensor at a predetermined time and converts the signal into digital format.

18. The apparatus of claim 14, wherein the micron-lens is made of glass with efficient polarization effect allowing light with all colors to penetrate into the semiconductor image sensor.

19. The apparatus of claim 14, wherein the micron-lens is made of a kind of plastic material with efficient polarization effect allowing light with all colors to penetrate into the semiconductor image sensor.

20. The apparatus of claim 14, wherein the readout circuit is comprised on a source follower with moderate amplification followed by an analog-to-digital-converter in the output of each column.
